(19) United States
(12) Patent Application Publication
(10) Pub. No.: US 2024/0383172 A1
(43) Pub. Date: Nov. 21, 2024

(54) MACHINE TOOL FOR CUTTING AND ENGRAVING SLABS

(71) Applicant: TONCELLI Dario, Bassano del Grappa (VI) (IT)

(72) Inventor: TONCELLI Dario, Bassano del Grappa (VI) (IT)

(21) Appl. No.: 18/688,449

(22) PCT Filed: Sep. 6, 2022
(86) PCT No.: PCT/IB2022/058348

§ 371 Date: Mar. 1, 2024

(30) Foreign Application Priority Data
Sep. 8, 2021 (IT) 102021000023249

(51) Int. Cl. B28D 1/00; B28D 1/04

(52) U.S. Cl. CPC B28D 1/003; B28D 1/043

(57) ABSTRACT

Machine tool for cutting and engraving slabs, including a support bench for supporting the slabs to be cut and/or engraved, at least one cutting disc for cutting the slabs mounted on a spindle, at least one engraving tool for engraving the slabs, and movement means for moving the at least one cutting disc and at least one engraving tool relative to the bench supporting the slabs. The at least one cutting disc and the at least one engraving tool are both mounted on a support head, the support head being movable relative to the support bench by means of the movement means.

The present invention relates to the technical sector of machining slabs and relates to a machine for cutting and engraving slabs, in particular slabs consisting of stone, agglomerate, ceramic or glass-ceramic material, or glass, or made using sintered stone.

According to the present state of the art machine tools for cutting slabs are known, said machine tools comprising one or more discs for cutting the slabs, connected to respective motor-driven spindles.

Such cutting discs are generally diamond discs, namely discs which are made using a metallic material lined with diamond studs or diamond grains along the edges of the discs.

Said machines also comprise a bench for supporting the slabs during the cutting operations and means for the relative movement of the slabs and the cutting disc.

In a very common type of cutting machine, the movement means comprise a pair of shoulders or fixed side walls and a horizontal beam which is slidably supported at its ends by the side shoulders.

The cutting disc with the respective spindle is generally mounted on a machining head and the latter is mounted on the bottom end of a sleeve; the sleeve is mounted on a carriage and is slidable along a vertical direction and the carriage is in turn slidably mounted on the beam.

The sliding of the beam along the side walls, the sliding of the carriage along the beam and the vertical sliding of the sleeve relative to the bench allow the movement—preferably interpolated—of the cutting disc in the space along the three Cartesian axes and results in the positioning thereof at a predetermined point above the support bench and therefore the slab to be cut.

The support bench may also be rotatable so as to adjust the cutting direction of the cutting disc.

The sliding of the sleeve along the vertical direction allows the machining head to be moved between a raised rest position, in which the cutting disc is raised and therefore spaced from the slab, and a lowered operative position, in which the cutting disc interacts with the slab.

Moreover, the machining head may be rotatable with respect to a vertical axis so as to adjust the cutting disc along the feeding direction during cutting of the slab; the cutting disc may also be inclined relative to the vertical direction so as to perform cuts which are inclined relative to the support bench.

During cutting of the slab, the cutting disc is moved horizontally and along a cutting direction with respect to the slab positioned on the support bench at a predetermined speed, called feeding speed, usually measured in m/min.

The penetration of the cutting disc into the material of the slab, also called “pass depth” and usually expressed in millimetres, instead determines the degree of the scoring or the incision performed.

During the execution of through-cuts in the slab, namely the cuts performed by means of a single pass as normally occurs, the feeding speed of the cutting disc is adjusted depending on the thickness of the slabs.

For example, during the cutting of slabs with a smaller thickness, the feeding speed may be kept at higher values compared to the feeding speed used during the cutting of slabs with a larger thickness.

Furthermore, during the machining of the slabs, the cutting speed, namely the peripheral or tangential speed along the edge of the cutting disc, usually expressed in m/s, must also be taken into consideration.

The tangential speed of the cutting discs, namely the speed at which the cutting discs come into contact with the slabs and strike the slabs and score the slabs, removing the material, is also set and adjusted depending on the type of material and/or the pass depth and/or the thickness of the slabs to be cut.

Furthermore, should it be required to increase the productivity of the machine tool, the operator must increase the feeding speed of the cutting disc or discs.

One drawback of the technical solutions indicated above is that the increase in the feeding speed causes greater wear of the cutting disc.

This drawback therefore results in a loss of cutting capacity of the cutting disc and the need to replace or perform periodic maintenance of the cutting disc.

Moreover, the cutting discs used in these machine tools must be cooled by means of water jets during the cutting operations, owing to the friction generated between them and the material of the slabs.

The drawback resulting from the need to perform water-cooling of the cutting discs is that machining sludge is generated during the cutting operations.

The machining sludge, which mainly contains water and dust materials removed from the slabs and the cutting discs, must be suitably disposed of.

As an alternative to the technical solutions described above, machine tools which perform a different type of cutting of the slabs, namely which use one or more engraving tools for engraving the slabs, have also been developed.

The separation of the two portions of the slab formed after engraving is performed by means of subsequent folding of the slab along the incision previously formed by means of the engraving tool; in this way the two portions of the slab are separated by means of a splitting action.

The separation step may be performed manually by an operator or in automated manner, namely by bringing the slabs into contact with an abutment element in the region of the incision and folding the two portions of the slab until fracture/splitting is obtained.

In the same way as the cutting discs described above, the engraving tools may be made of diamond-coated material; however, usually these engraving tools are made of ceramic material, such as Widia.

These additional machine tools are used in particular with slabs having thicknesses smaller than the slabs which are cut using cutting discs and made of particularly hard and compact materials.

In this connection, the thickness of the slabs intended to be engraved and cut by means of these machine tools may have a maximum value of about 20 mm and is preferably between 6 mm and 12 mm; the material of these slabs is chosen from the group comprising glass, sintered stone, glass-ceramic and ceramic material or very hard and fragile stone materials.

In these machines, the engraving of the slabs before separation is performed in dry conditions, since the engraving tools do not need to be cooled by means of water jets, as instead occurs in the case of the cutting discs. Therefore, these machine tools do not produce machining sludge during the engraving operations.

Moreover, in these machine tools the feeding speed of the engraving tool is equal to about 45-50 m/min. and therefore considerably faster than the feeding speed which can be used with the cutting discs, which is generally not higher than 15 m/min.

As a matter of fact, the use of engraving tools enables the use of the cutting discs to be limited and reduced and therefore the wear thereof to be substantially reduced.

The limitation of these further solutions is that they do not offer the same cutting efficiency and precision for slabs which have thicknesses greater than those indicated above or which are made of materials different from those indicated above.

Therefore, plants and machines which use the diamond cutting disc and the engraving tool for cutting slabs in a combined manner have also been developed.

In these machines, the use of the cutting disc and the engraving tool is sequential and the superficial pre-cut made using the cutting disc allows the subsequent engraving of the slab by the engraving tool to be simplified.

Furthermore, in order to make pre-cuts and longitudinal and transverse incisions which are perpendicular to each other or on any case at an angle on the same slab, the slab must be rotated or loaded onto a feeding belt in a position rotated through 90°, or through a few degrees, with respect to the position in which the slab underwent the previous series of pre-cuts or incisions.

Therefore, one drawback of these latter solutions is that these plants have a limited flexibility as well as a limited production capacity.

In these plants, the separation of the engraved portions is performed automatically in a station located downstream of the engraving zone; the engraved slabs are transported into this station by means of a suitable feeding device.

The drawback arising from this configuration is that these plants may occupy a significant area and have large dimensions.

The main object of the present invention is to provide a machine tool for cutting and engraving slabs which is able to solve the aforementioned drawbacks.

A particular task of the present invention is to provide a machine tool of the type indicated above which may be used for cutting and engraving slabs which have different thicknesses and are made of different materials.

A further task of the present invention is to provide a machine tool of the type indicated above which has a greater flexibility than the similar machines known in the sector.

A further task of the present invention is to provide a machine tool of the type indicated above which has shorter machining times than the similar machines known in the sector.

A further task of the present invention is to provide a machine tool of the type indicated above which allows the removal and the movement of the slabs or of the cut and separated portions of the slabs.

The object and the main tasks described above are achieved with a machine tool for cutting and engraving slabs according to claim 1.

In order to illustrate more clearly the innovative principles of the present invention and its advantages compared to the prior art, an example of embodiment of the machine tool for cutting and engraving slabs according to the present invention will be described below with the aid of the accompanying drawings. In particular, in the figures:

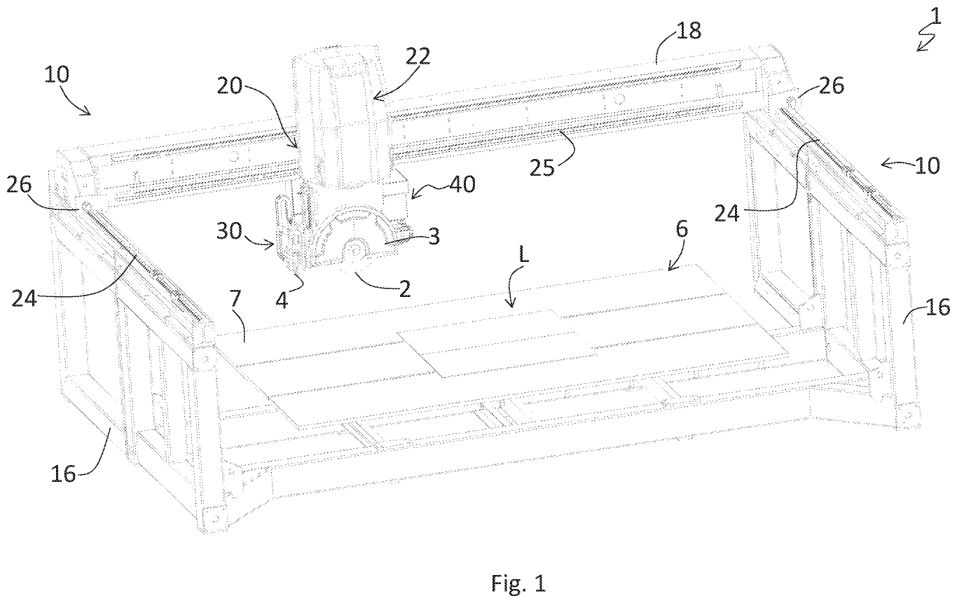

FIG. 1 shows a perspective view of the machine tool for cutting and engraving slabs according to the present invention in a first embodiment;

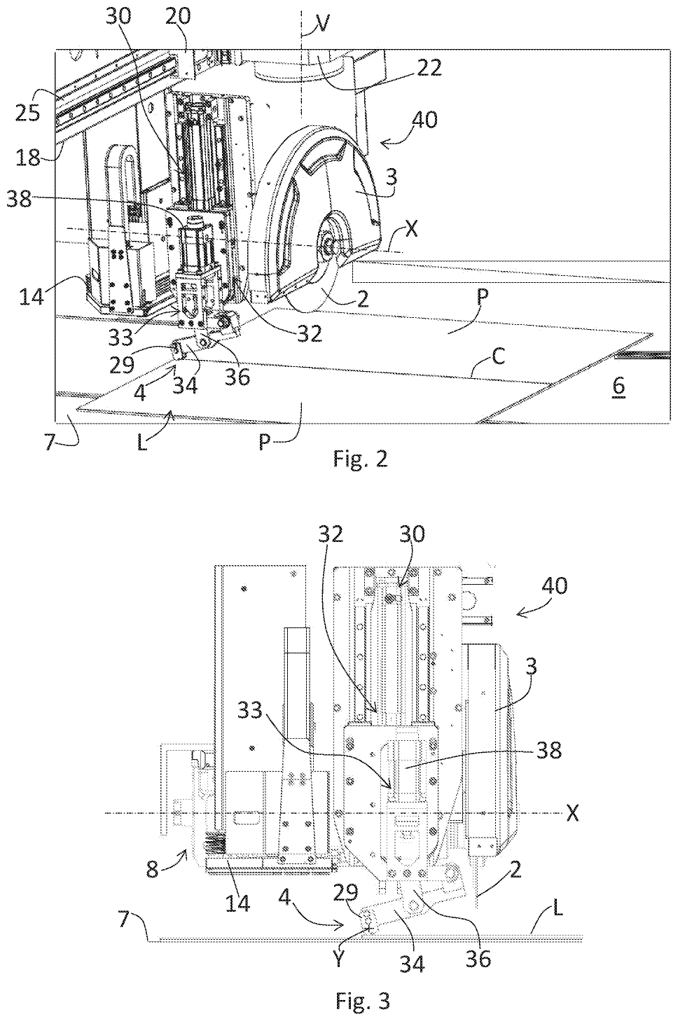

FIGS. 2 and 3 are a perspective view and side view, respectively, of a detail of the machine tool according to FIG. 1 in a first operative configuration;

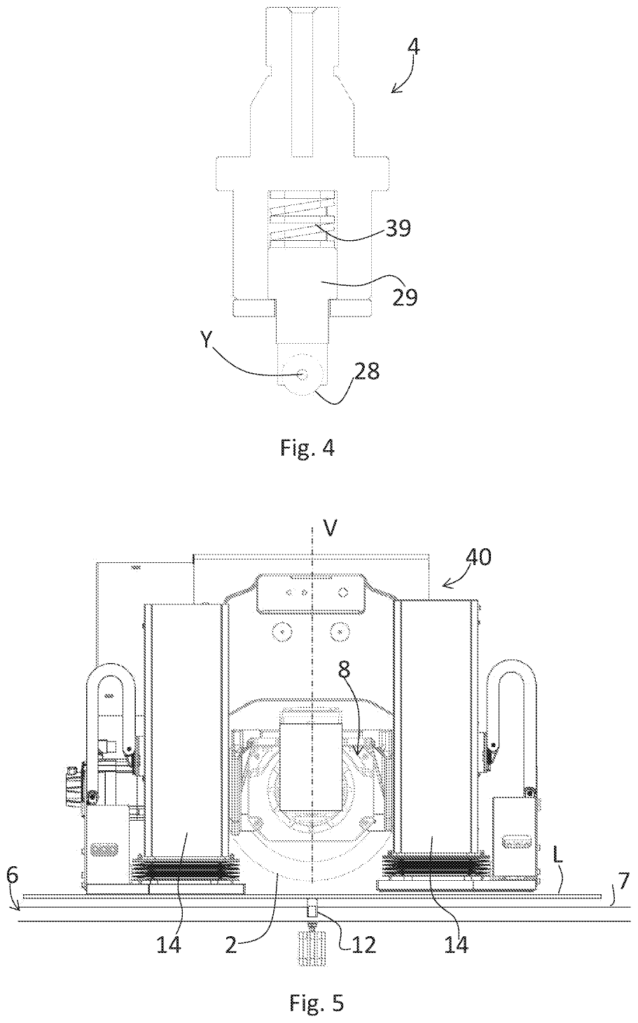

FIG. 4 is a schematic cross-sectional view of the engraving tool of the machine tool;

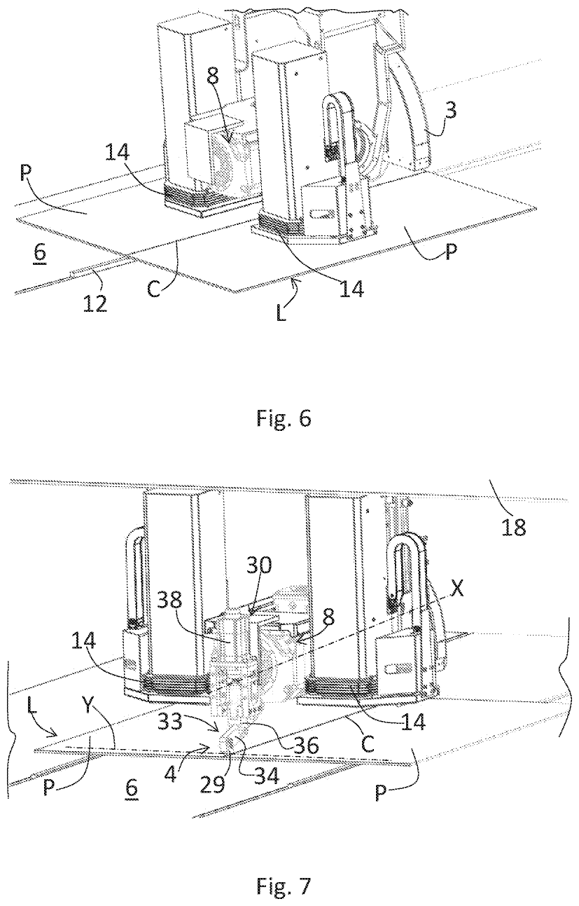

FIGS. 5 and 6 are a rear view and perspective view, respectively, of a detail of the machine tool according to FIG. 1 in a second operative configuration;

FIG. 7 is a perspective view of a detail of a second embodiment of the machine tool;

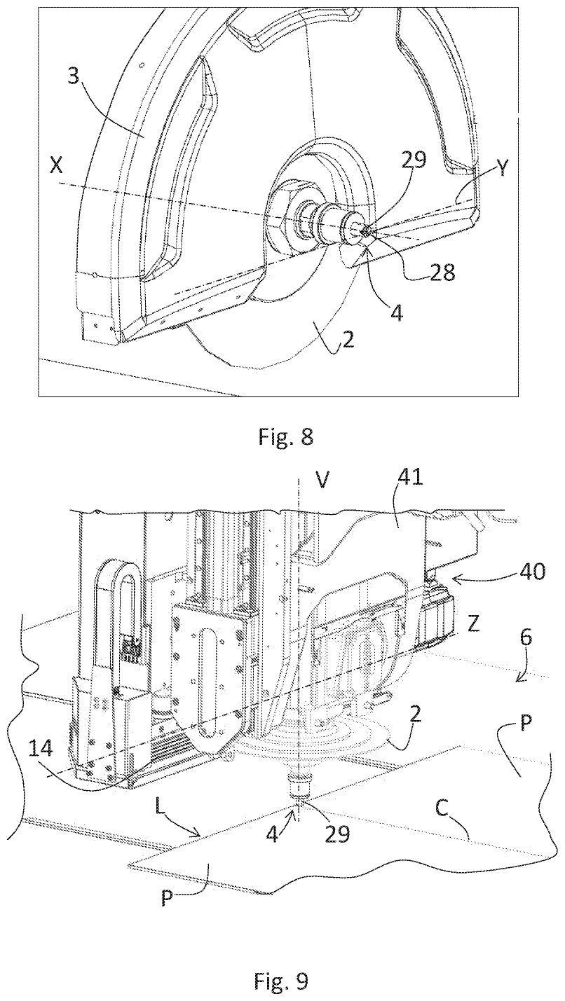

FIGS. 8 and 9 are perspective views of a detail of a third embodiment of the machine tool in two different operative configurations;

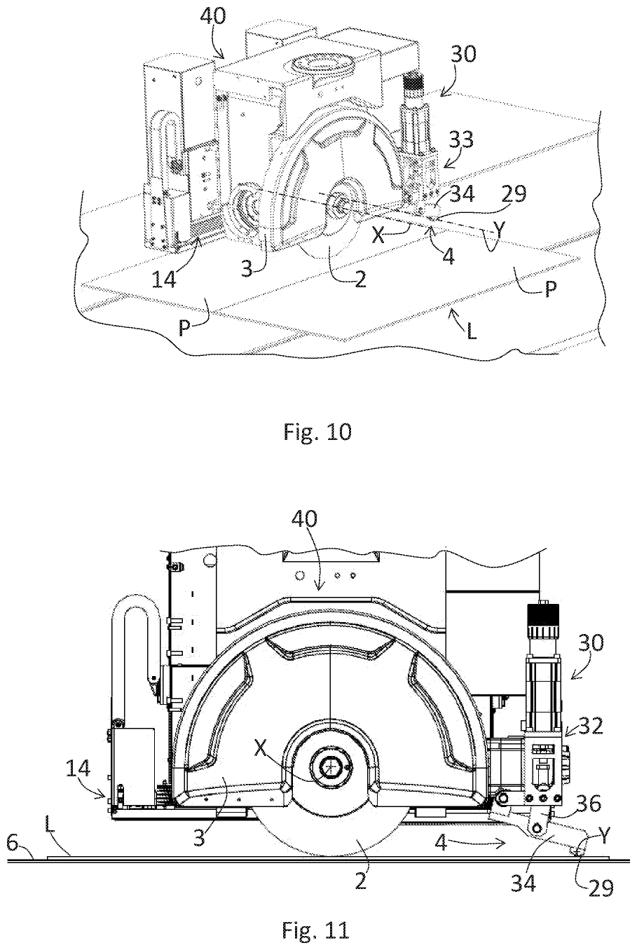

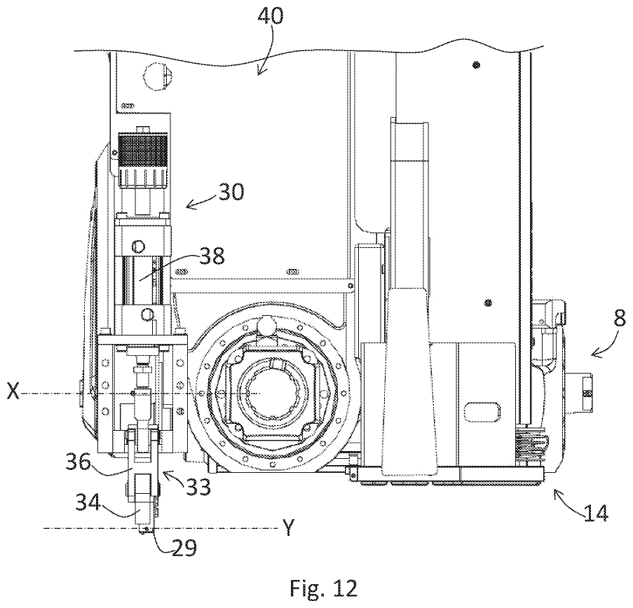

FIGS. 10, 11 and 12 are, respectively, a perspective view, a front view and a side view of a detail of a fourth embodiment of the machine tool, FIGS. 10 and 11 showing the machine tool in two different operative configurations.

The present description, provided only for illustrative purposes and not limiting the scope of the invention, refers to a machine tool for cutting and engraving slabs.

In the attached figures the machine tool for cutting and engraving slabs is denoted overall by the reference number 1.

The machine tool according to the present invention is suitable in particular for cutting and engraving slabs L consisting of stone, stone-like, agglomerate, ceramic or glass-ceramic material, or glass, or made using sintered stone.

Conveniently, the cut is made by means of at least one cutting disc 2 preferably in large-thickness slabs L made of stone or agglomerate material.

The incision, instead, is made by means of at least one engraving tool 4 preferably in slabs L made of glass-ceramic or ceramic material, or glass or sintered stone and having a smaller thickness, i.e. with a maximum value of about 20 mm and preferably ranging between 6 mm and 12 mm.

However, as explained further below, the at least one cutting disc 2 and the at least one engraving tool 4 may also be used together on a single slab.

As shown more clearly in FIG. 1, the machine tool 1 for cutting and engraving slabs L comprises:
a support bench 6 supporting the slabs L to be cut and/or engraved and having a horizontal upper surface 7, i.e. surface parallel to the ground;
at least one cutting disc 2 mounted on a spindle 8 with a respective drive system, as shown more clearly in FIGS. 3, 5 and 6;
at least one engraving tool 4 for engraving the slabs L;
movement means 10 for moving the at least one cutting disc 2 and the at least one engraving tool 4 relative to the support bench 6 supporting the slabs L.

The support bench 6 is generally fixed and may comprise preferably at least one abutment element 12 designed to allow separation by means of splitting od the two portions P of the slab L obtained following formation of the incision C; this feature is shown more clearly in FIGS. 5 and 6.

In particular, the abutment element 12 is mounted on the upper surface 7 of the support bench 6.

In this regard, the slabs L are placed in contact and pressed manually or in an automated manner, as will be explained below, against the abutment element 12 along the incision C previously formed by the at least one engraving tool 4.

The folding of the two portions P of the slab L along the incision C resulting from the pressure applied against the abutment element 12 allows the separation of the two portions P of the slab L by means of splitting/fracturing.

In an alternative embodiment (not shown in the figures) two longitudinal abutment elements may be provided positioned on the support bench; in this way the separation of the two portions of the slab after the formation of the incision is performed by means of pressing along or close to the incision on the slab.

The machine tool 1 also comprises suction handling means 14, of the type shown in FIGS. 2 and 3, 5 and 6, 9 and 10-12.

The suction handling means 14 perform picking-up and movement of the slabs L, of the cut portions of the slabs L and of the two portions P of the slabs, obtained following engraving and the associated splitting with separation.

The suction handling means 14 are configured to bring the engraved slabs L into contact with the abutment element 12 in an automated manner as described above so as to perform separation of the portions P by means of splitting/fracturing.

The suction handling means 14 are movable along a respective vertical direction so as to pass from a raised inoperative position spaced from the slabs L positioned on the support bench 6, into a lowered operative position where they are in contact with the slabs L.

After picking up the slabs L or slab portions P, the suction handling means 14 may be raised so as to move them relative to the support bench 6.

In particular, the suction handling means 14 may pick up the slabs L and if necessary press them against the abutment element 12 along the incision C made by the engraving tool 4, as shown in FIG. 5, until they are split.

In this regard, the suction handling means 14 comprise a pair of suckers, which are preferably cushioned, for picking up the slabs L or the portions P of the slabs L obtained following engraving.

Advantageously, the movement means 10 comprise:
a pair of fixed side shoulders 16;
a beam 18 slidably mounted at its ends on the fixed side shoulders 16;
a carriage 20 slidably mounted on the beam 18;
a sleeve 22 mounted on the carriage 20 and slidable relative to the carriage 20 along a vertical direction.

The movement means 10 described above are shown overall in FIG. 1.

In particular, in FIG. 1 it can be seen that longitudinal guides 24 are provided on top of the shoulders 16 and that the beam 18 is provided with sliding shoes 26 at its ends for slidable engagement with the longitudinal guides 24.

Furthermore, the beam 18 is provided with guides 25 for the sliding movement of the carriage 20, as shown in FIGS. 1 and 2.

The cutting disc 2 is rotatable about a respective rotation axis N which may be parallel or inclined relative to the upper surface 7 of the support bench 6; moreover, the cutting disc 2 is provided in a manner known per se with a protective housing 3.

Preferably, the at least one cutting disc 2 is diamond-coated, namely has along the cutting edge diamond studs or diamond grains having dimensions ranging between a few microns and several tens of microns.

Furthermore, the machine tool 1 preferably comprises water jets for cooling the disc 2 during cutting of the slabs L, not visible in the attached figures.

In the embodiment shown in the figures, the at least one engraving tool 4 is formed by a roller wheel 28, shown schematically in FIG. 4; the roller wheel 28 has a shaped profile, preferably with a V-shaped edge.

The roller wheel 28 is made of hard material, preferably tungsten carbide, otherwise known as Widia.

As shown in FIGS. 2 and 3, 7-9 and 10-12, the wheel 28 is mounted on a support 29 and is rotatable about a rotation axis Y.

The wheel 28 of the engraving tool 4 has a diameter which is smaller than the diameter of the cutting disc 2.

As shown more clearly in FIGS. 1-4, 7 and 10-12, the at least one engraving tool 4, namely the roller wheel 28 mounted on the support 29, is mounted on a device 30 comprising a slide 32 and a movement mechanism 33 for moving the engraving tool 4 mounted on the slide 32.

The slide 32 is movable along a respective vertical direction and the movement mechanism 33 is designed to bring the at least one engraving tool 4 from an inoperative position raised with respect to the slab L into an operative position in contact with the slab L to be engraved after the slide 32 has been lowered, and vice versa. The engraving tool 4 in the operative position is shown in FIGS. 2 and 3, 7 and 11.

As shown more clearly in FIGS. 2-4, 7 and 10-12, the movement mechanism 33 indicated above advantageously comprises:
a pivoted lever 34 with a first end connected to the engraving tool 4, in particular to the support 29, and a second end hinged with the slide 32;
a bar 36 with a first end hinged at the centre of the pivoted lever 34 and a second end hinged on a stem of a pneumatic cylinder 38 integral with the slide 32;
a thrust spring 39 designed to keep the at least one engraving tool 4 pressed against the slab L to be engraved in the operative position, of the type shown in FIG. 4.

The operation of the movement mechanism 33 involves operation of the pneumatic cylinder 38 with consequent exiting of the stem and lowering of the bar 36 and the pivoted lever 34; in this way the wheel 28 reaches the operative position and comes into contact with the slab L.

Then, after making the incision on the slab, the stem of the pneumatic cylinder 38 is retracted and the bar 36 is raised together with the pivoted lever 34 so that the wheel 28 is raised from the slab L, reaching the inoperative position.

In accordance with a particular aspect of the invention, the at least one cutting disc 2 and the at least one engraving tool 4 are both mounted on a support head 40 and this support head 40 is also movable relative to the support bench 6 by the movement means 10.

The support head 40 is mounted on the sleeve 22, in particular on the bottom end of the sleeve 22, and is rotatable relative to the sleeve 22 at least about a substantially vertical axis V.

The rotatable support head 40 with the at least one cutting disc 2 and the at least one engraving tool 4 may be suitably positioned along a longitudinal or transverse direction by means of movement of the carriage 20 along the beam 18 and/or the beam 18 along the side shoulders 16 in order to perform the cuts or incisions.

In accordance with an alternative embodiment of the invention, not shown in the attached figures, the support head 40 may be fixed with respect to the sleeve 22 and the support bench 6 supporting the slabs L may be rotatable relative to an associated vertical axis V.

In a first embodiment shown in FIGS. 1-3, the at least one cutting disc 2 and the at least one engraving tool 4, formed by the roller wheel 28 mounted on the movement mechanism 33 by means of the support 29 are positioned on adjacent sides of the support head 40.

In a second embodiment shown in FIG. 7, the at least one cutting disc 2 and the at least one engraving tool 4 with the device 30 are positioned on opposite sides of the support head 40, respectively on the front side and the rear side of the support head 40.

In this embodiment also, the engraving tool 4 is formed by the roller wheel 28 mounted on the movement mechanism 33 by means of the support 29, but differently from the first embodiment it is interposed with the device 30 between the suction handling means 14 described above.

In both the embodiments described above, the rotation axis X of the cutting disc 2 and the rotation axis Y of the roller wheel 28 are horizontal and perpendicular to each other, as shown more clearly in FIGS. 3 and 7.

It should also be noted that the plane of the cutting disc 2 and the plane of the roller wheel 28 are perpendicular to each other.

In the third embodiment shown in FIGS. 8 and 9, the support 29 of the engraving tool 4, namely of the wheel 28, is mounted coaxially with respect to the rotation axis N of the cutting disc 2, being mounted on the extension of the shaft of the spindle 8 of the cutting disc 2.

In this embodiment also, the rotation axis X of the at least one cutting disc 2 is perpendicular to the rotation axis Y of the wheel 28.

As shown in the figures, this embodiment does not comprise the movement mechanism described for the first two embodiments.

Moreover, in this latter embodiment, the support head 40 is a bi-rotational head, namely a head rotatable both about the vertical axis V as mentioned above and about a horizontal axis Z so as to bring the cutting disc 2 and the engraving tool 4 into contact with the slab to be cut or engraved, as shown in FIG. 9.

In a manner known per se, the bi-rotational support head 40 comprises a fork 41 mounted on the sleeve 22 and preferably rotatably connected to the bottom end of the sleeve 22 so as to rotate about the vertical axis V.

In this embodiment the engraving tool 4, with the device 30 comprising the slide 32 and the movement mechanism 33 is mounted on the fork 41.

This configuration of the support head 40 allows the cutting disc 2 to be positioned with the respective spindle and the engraving tool 4 also in an inclined position relative to the horizontal plane and to the fork 41, so as to form inclined cuts or incisions.

In this third embodiment, if the support head 40 is inclined in order to make cuts inclined with respect to a vertical plane, the engraving tool 4 remains in vertical position.

In accordance with an embodiment not shown in the figures, the support head 40 supporting the first two embodiments may be a bi-rotational head so as to allow the formation of inclined cuts by the cutting disc 2.

In the fourth embodiment of the machine tool 1 shown in FIGS. 10-12, the at least one engraving tool 4, comprising the roller wheel 28, is mounted on the support head 40 in a position alongside the cutting disc 2, in a manner similar to that of the first embodiment.

However, differently from the preceding embodiments, in the fourth embodiment the at least one cutting disc 2 and the roller wheel 28 of the engraving tool 4 are arranged in line, with the rotation axis X of the cutting disc 2 parallel to the rotation axis Y of the roller wheel 28, as shown more clearly in FIGS. 10-12.

This configuration allows the formation, on the same slab L and with a single pass, of a pre-cut by means of the cutting disc 2 and the incision C by means of the roller wheel 28 inside the groove of the pre-cut, as shown in FIG. 11.

The pre-cut and the incision may be performed with a cooling water flow or advantageously in dry conditions with suction of the dust produced by the disc.

In the embodiments described above, the suction handling means 14 are also mounted on the support head 40; however, these suction handling means 14 are movable along the respective vertical direction independently of the movement mechanism 33 of the engraving tool 4, where provided.

In the case of a support head 40 of the bi-rotational type, the suction handling means 14 may be mounted on the fork 41 of the support head 40 described above together with the engraving tool 4.

In this way, if the cutting disc 2 is inclined relative to the horizontal in order to perform inclined cuts, both the engraving tool 4 and the suction handling means 14 remain in a substantially vertical position and can be used independently of the cutting disc 2.

In a manner known per se the machine tool 1 comprises a control unit, not shown in the attached figures, for operation of the movement means 10, of the drive system of the spindle 8, of the at least one cutting disc 2, of the movement mechanism 33 for moving the at least one engraving tool 4 and of the suction handling means 14.

The machine tool 1 may also comprise a tool-holder magazine which has, stored inside it, engraving tools of different shapes and sizes so as to allow automatic changing of the tools if they become worn or if the operator must perform different machining operations. The magazine is not shown in the attached figures.

Operationally speaking, the method for using the machine tool 1 according to the present invention may therefore involve a step of making one or more pre-cuts on a surface of the slabs L by means of the at least one cutting disc 2 and a subsequent step of making one or more incisions C by means of the at least one engraving tool 4 on the same surface of the slabs L and in the groove of the pre-cuts.

This operating mode is preferably employed when the surface of the slabs is not smooth, but is uneven/worked and preferably uses the fourth embodiment of the machine tool 1 described above.

Alternatively, the method of using the machine tool 1 may involve a step of making one or more pre-cuts by means of the at least one cutting disc 2 on a surface of the slabs L and a subsequent step of making one or more incisions C in the opposite surface of the slabs L along the pre-cuts by means of the at least one engraving tool 4, after turning the slabs L over. This operating mode is preferably used when the slabs are very thick, for example more than 12 mm thick.

From the above description it is now clear how the machine tool for cutting and engraving slabs according to the present invention is able to achieve advantageously the predefined objects.

In particular, the characteristic feature whereby both the cutting disc and the engraving tool are mounted on the support head increases the flexibility and the productivity of the machine tool.

Moreover, the at least one cutting disc and the at least one engraving tool may be used in an alternating and selective manner, making the machine tool particularly suitable for being used for cutting and engraving with splitting of slabs having different thicknesses and made of different materials.

Owing to the particular configuration of the machine tool according to the present invention it is possible to select in each case the operating conditions which are most suitable for performing the cuts, the incisions and the splitting of the slabs.

Obviously, the above description of embodiments applying the innovative principles of the present invention is provided by way of example of these innovative principles and must therefore not be regarded as limiting the scope of the rights claimed herein.

1. A machine tool for cutting and engraving slabs comprising:
a support bench for supporting the slabs to be cut and/or engraved;
at least one cutting disc for cutting the slabs mounted on a spindle;
at least one tool for engraving the slabs; and
movement means for moving the at least one cutting disc and the at least one engraving tool relative to the support bench for supporting the slabs;
characterized in that said at least one cutting disc and said at least one engraving tool are both mounted on a support head, said support head being movable relative to the support bench by the movement means.

2. The machine tool according to claim 1, characterized in that said at least one engraving tool is mounted on a device comprising a slide which is movable along a vertical direction.

3. The machine tool (1) according to claim 2, characterized in that said device comprises a movement mechanism mounted on said slide and designed to bring said at least one engraving tool from an operative position in contact with the slab to be engraved into an inoperative position raised from the slab to be engraved.

4. The machine tool according to claim 3, characterized in that said movement mechanism comprises:
a pivoted lever with a first end connected to the engraving tool and a second end hinged on said slide;
a bar with a first end hinged at the centre of said pivoted lever and a second end hinged on a stem of a pneumatic cylinder; and
a thrust spring designed to keep said at least one engraving tool pressed against the slab in said operative position.

5. The machine tool according to claim 1, characterized in that said movement means comprise:
a pair of fixed side shoulders;
a beam slidably mounted on said side shoulders;
a carriage slidably mounted on said beam; and
a sleeve mounted on said carriage and slidable relative to the carriage along a vertical direction;
said support head being mounted on said sleeve.

6. The machine tool according to claim 1, characterized in that said support head is rotatable at least about a vertical axis.

7. The machine tool according to claim 1, characterized in that said engraving tool is a roller wheel with a shaped profile.

8. The machine tool according to claim 7, characterized in that said roller wheel is made of tungsten carbide.

9. The machine tool according to claim 1, characterized in that said at least one cutting disc and said at least one engraving tool are arranged on adjacent sides of said support head.

10. The machine tool according to claim 1, characterized in that said at least one cutting disc and said at least one engraving tool are arranged on opposite sides of said support head.

11. The machine tool according to claim 1, characterized in that said at least one engraving tool is mounted on a support which is coaxially mounted relative to the rotation axis of the cutting disc.

12. The machine tool according to claim 9, characterized in that the rotation axis of said cutting disc is perpendicular to the rotation axis of said roller wheel.

13. The machine tool according to claim 1, characterized in that said support head is a bi-rotational head and comprises a fork mounted on said sleeve, the at least one engraving tool being mounted on said fork.

14. The machine tool according to claim 7, characterized in that said cutting disc and said roller wheel are arranged in line, with the rotation axis of the cutting disc parallel to the rotation axis of the roller wheel.

15. The machine tool according to claim 1, further comprising suction handling means mounted on said support head.

16. The machine tool according to claim 15, characterized in that said support head is a bi-rotational head and comprises a fork mounted on said sleeve, said suction handling means being mounted on said fork.

17. The machine tool according to claim 1, characterized in that said support bench comprises at least one abutment element for separating the slabs by means of splitting once engraving by said engraving tool has been performed.

18. The machine tool according to claim 10, characterized in that the rotation axis of said cutting disc is perpendicular to the rotation axis of said roller wheel.

19. The machine tool according to claim 11, characterized in that the rotation axis of said cutting disc is perpendicular to the rotation axis of said roller wheel.

20. The machine tool according to claim 8, characterized in that said cutting disc and said roller wheel are arranged in line, with the rotation axis of the cutting disc parallel to the rotation axis of the roller wheel.
